(19) United States
(12) Patent Application Publication
(10) Pub. No.: US 2025/0279618 A1
(43) Pub. Date: Sep. 4, 2025

(54) Housing Assembly for an Electrical Connector

(71) Applicant: TE Connectivity Solutions GmbH, Schaffhausen (CH)

(72) Inventors: Ivan IVANOV, Schaffhausen (CH); Jens SCHWINDT, Schaffhausen (CH); Jochen FERTIG, Schaffhausen (CH); Michael HASPEL, Schaffhausen (CH); Michael BURGHARD, Schaffhausen (CH)

(73) Assignee: TE Connectivity Solutions GmbH, Schaffhausen (CH)

(21) Appl. No.: 19/066,219

(22) Filed: Feb. 28, 2025

(30) Foreign Application Priority Data
Mar. 4, 2024 (DE) 102024106165.0

(51) Int. Cl. H01R 13/6592

(52) U.S. Cl. CPC H01R 13/6592

(57) ABSTRACT

A housing assembly for an electrical connector having a shielding sleeve made of electrically conductive material. The shielding sleeve includes a central receptacle that axially penetrates the shielding sleeve for receiving at least one shielded cable. At least one contact sleeve module made of electrically conductive material is inserted into the central receptacle. The at least one contact sleeve module has at least one passage opening for the at least one shielded cable and is provided with at least one contact section for contacting a shielding of the at least one shielded cable and is frictionally affixed in the shielding sleeve when in the assembled state.

### CROSS REFERENCE TO RELATED APPLICATIONS

This application claims priority to and the benefit of German Patent Application No. 102024106165.0 filed Mar. 4, 2024, which is hereby incorporated by reference in its entirety.

### BACKGROUND OF THE INVENTION

The present invention relates to a housing assembly for an electrical connector, wherein the housing assembly comprises a shielding sleeve and at least one contact sleeve module which is inserted into the shielding sleeve and affixed in the shielding sleeve in a frictionally engaged manner when in the assembled state.

In electrical connectors, such housing assemblies are used for shielding in order to reduce or exclude electromagnetic interference.

The electrical connectors are often provided with an outer housing that serves as a shielding and into which a respective contact sleeve is inserted for each individual cable. The shielding of the cable is connected in an electrically conductive manner to the contact sleeve, and the at least one contact sleeve is spot-welded to the outer housing. This type of production is very complex. Good electrical contact between the contact sleeve and the outer housing is not always ensured.

### SUMMARY OF THE INVENTION

The invention is therefore based on the objective of improving the housing assembly mentioned at the outset such that it is easier to manufacture and enables more reliable contact between the shielding sleeve and the contact sleeve module.

The present invention solves this problem, firstly, by way of a housing assembly for an electrical connector, wherein the housing assembly comprises a shielding sleeve made of electrically conductive material, wherein the shielding sleeve comprises a central receptacle axially penetrating the shielding sleeve for receiving at least one shielded cable, wherein at least one contact sleeve module made of electrically conductive material is inserted into the central receptacle, and wherein the contact sleeve module comprises at least one passage opening for the at least one shielded cable, is provided with at least one contact section for contacting a shielding of the at least one shielded cable, and is affixed in the shielding sleeve in a frictionally engaged manner when in the assembled state.

This solution simplifies assembly because welding can be dispensed with. At the same time, the frictional engagement between the shielding sleeve and the at least one contact sleeve module ensures a good electrical connection. The shielding sleeve is used in particular for electromagnetic shielding.

The invention can be further improved by the following configurations, each of which is advantageous in itself, independent of one another, and can be combined with one another as desired.

In an advantageous embodiment, the shielding sleeve and/or the at least one contact sleeve module of the housing assembly can be made of metal, for example steel, copper or aluminum, in order to ensure reliable electrical contact of the at least one contact sleeve module with the shielding sleeve. Sheet metal can be used for these components in order to have good moldability during production and a low weight of the components. Alternatively, the shielding sleeve and/or the at least one contact sleeve module can also be manufactured from plastic material that contains metal and/or is electrically conductive.

The shielding sleeve can be deep-drawn, which incurs only low costs for the parts and allows for great flexibility with regard to shapes, materials, and sizes.

In an advantageous embodiment, the shielding sleeve can comprise recesses and/or elevations or projections on the outer side of its circumference. The recesses and/or elevations can serve to improve handling and simplify assembly. The recesses and/or elevations can alternatively or cumulatively serve as guides that simplify positioning of the shielding sleeve in a housing. The elevations and/or recesses can also be part of a coding that prevents the shielding sleeve from being inserted incorrectly. A recess can be configured, for example, in the form of an axially extending channel, in particular a coding channel, or an axially extending groove. The elevations can be configured as ribs, in particular coding ribs, extending in the axial direction. Finally, the elevations and/or recesses can also form positive-fit or frictionally engaged elements that are configured to be engageable with the surrounding housing of the shielding sleeve.

In one configuration, the shielding sleeve can comprise an end wall that defines the central receptacle in the axial direction. The other end of the central receptacle in the axial direction can be completely open.

The shielding sleeve can have a taper in which the shielding sleeve tapers in a direction away from the central receptacle. The taper can extend axially to the end wall of the shielding sleeve. The taper can be configured in steps and end with its smallest diameter at the end wall of the shielding sleeve. This provides a compact design and saves material and space and in particular increases compatibility with components inside and outside the shielding sleeve.

When inserted, the at least one contact sleeve module in one configuration nestles against the end wall of the shielding sleeve, in particular with an intermediate wall or transition region facing in the axial direction, in order to enable electrical contact over as large an area as possible.

The at least one contact sleeve module can be held in the shielding sleeve by way of a press fit, which is advantageous for precise alignment and a play-free connection that does not require any additional fastening elements.

The at least one contact sleeve module can be provided, at least in the regions in which it is frictionally engaged with the shielding sleeve, with projections that are spaced from one another on its outer circumference and that project outwardly.

The frictional engagement with the shielding sleeve is preferably established by way of the projections. The number and shape of the projections can be used to precisely dose and adjust the force, with which the at least one contact sleeve module must be pressed into the shielding sleeve, as well as the size of the contact region and thus the electrical transition resistance. In particular, the projections can have different heights. The projections can then be adapted to the shape of the shielding sleeve for ensuring uniform contact force distribution of the individual points of contact over the entire circumference.

The shielding sleeve can be provided with a smooth wall in the region of the central receptacle in which the shielding sleeve is engaged in a frictionally engaged manner with the projections of the at least one contact sleeve module. Alternatively, the region of the central receptacle in which the shielding sleeve is frictionally engaged with the projections of the at least one contact sleeve module can likewise be provided with projections. In the assembled state of the at least one contact sleeve module, its projections can be located between the projections of the central receptacle. The regions between the projections of the at least one contact sleeve module and/or the central receptacle are preferably flat or smooth in order to avoid surface contact.

In an advantageous embodiment, at least two contact sleeve modules can be frictionally engaged with one another when inserted in the shielding sleeve. The contact sleeve modules inserted in the shielding sleeve are thereby supported by one another and by the shielding sleeve transversely to the axial direction. The contact sleeve modules are therefore affixed to one another as a package and in the shielding sleeve by frictional engagement.

At least two contact sleeve modules of the contact sleeve modules are preferably configured to be identical, which simplifies production, reduces complexity, and enhances frictional engagement. The at least two identical contact sleeve modules can be placed against each other in a mirrored and/or rotated manner and combined with one another. For example, two, three, four or five preferably identically configured contact sleeve modules can be pressed into the central receptacle in a frictional engaged manner. In another configuration, however, more than five, for example eight or nine preferably identical contact sleeve modules can be inserted into the central receptacle in a frictional engaged manner.

The at least two contact sleeve modules can be provided with projections spaced from one another on their outer circumference, in particular in the regions in which they are in frictional engagement with the at least one other contact sleeve module.

The projections can be spaced from one another in the circumferential direction of the respective contact sleeve module. The projections can advantageously be configured to be axially elongated and form a linear contact with the shielding sleeve and the at least one other contact sleeve module. For example, the projections can be configured as ribs that extend axially in their longitudinal direction. In particular, the ribs can be arranged having the same spacing from one another around the outer circumference of the respective contact sleeve module. The ribs can be formed to be rounded or pointed. Ribs extending in the axial direction can be easily manufactured by deep drawing or can be more easily removed from the mold during manufacturing.

In one variant, the outer circumference of the contact sleeve module can be configured to be wave-shaped. Here, for example, the wave crests can be formed by rounded ribs, while the wave troughs in between are formed by a negative shape—i.e. a groove that has the contour of the ribs and runs parallel to the ribs.

Another alternative can comprise projections configured as nubs on the outer circumference of the contact sleeve module, which then, in the state of being inserted into the shielding sleeve, are in at least approximately punctiform contact with another contact sleeve module and/or the shielding sleeve. These embodiments with the linear and/or punctiform contact ensure non-surface contact over the entire circumference, thus making it easier to press into the at least one contact sleeve module while simultaneously ensuring a long-lasting press fit and improving electrical contact. The projections configured as nubs can be aligned one behind the other in the axial direction. They therefore correspond to a rib being non-continuous in the axial direction.

If two adjacent contact sleeve modules, which are provided with projections on their outer circumference, abut one another in the assembled state or the state inserted into the shielding sleeve, then a projection of one contact sleeve module is preferably located between projections of the other contact sleeve module. For example, a wave is then disposed in a trough. As explained above, a trough does not have to be formed to be concave. For example, a smooth or flat trough can improve electrical contact due to only line-like or punctiform contact.

In an advantageous embodiment, the common outer contour formed by the contact sleeve modules inserted into the shielding sleeve can be configured in a plane transverse to the axial direction in a manner that is complementary to the inner contour of the shielding sleeve. In particular, a common outer contour can be pressed into the inner contour of the shielding sleeve to create the frictional engagement. For this purpose, the common outer contour preferably has an oversize as compared to the inner contour of the shielding sleeve or as compared to the central receptacle.

The outer contour of a contact sleeve module can nestle at least in sections against the inner contour of the shielding sleeve and/or the outer contour of at least one other contact sleeve module so that the contact sleeve modules are in contact with each other as well as with the shielding sleeve as uniformly as possible over as large an area of their outer circumference as possible. This configuration makes it possible to reduce the transition resistance.

The central receptacle can have an elliptical or circular cross-section. Accordingly, the regions of the at least one contact sleeve module that are in frictional engagement with the shielding sleeve can have an arc shape that is complementary to the elliptical or circular cross-section. The large contact areas lead to low electrical transition resistance and at the same time increase the frictional engagement.

On the sides on which the contact sleeve modules abut one another, they can be flattened in one configuration, in particular flattened on one side, in order to achieve improved line contact. In particular, the projections of one of the contact sleeve modules can abut the respective complementary surface of the at least one other contact sleeve module. Preferably, a projection of a contact sleeve module abuts an in particular flat or level area of the other contact sleeve module. The sections can be rotationally symmetrical and have a wave-shaped configuration in sections. The base area of the at least one contact sleeve module in the axial direction can have the shape, for example, of approximately a circular sector, where the corners are preferably rounded.

The contact section of the contact sleeve module can be configured in the shape of a hollow cylinder, for example, as a hollow cylindrical extension or stub, in order to ensure high stability and a simple connection for shielding a cable. The contact section can project, for example, from the intermediate wall of the contact sleeve module in the axial direction. The hollow cylindrical extension or stub can project from the shielding sleeve when the contact sleeve module is inserted in order to simplify assembly.

The contact sleeve module can comprise a clamping section, on the outer circumference of which is the region that is in frictional engagement with the shielding sleeve and/or another contact sleeve module. This clamping section can comprise the projections that create the frictional engagement. When the contact sleeve module is assembled, the clamping section is located in the shielding sleeve or its central receptacle. The clamping section can project from the intermediate wall in the axial direction in the shape of a collar.

The contact section of the contact sleeve module preferably has a smaller clearance than the clamping section of the contact sleeve module. The clamping section in the transition to the contact section can comprise the intermediate wall pointing in the axial direction. In other words, the intermediate wall pointing in the axial direction can form the transition between the contact section and the clamping section. The intermediate wall can extend in an annular shape around the contact section and, in particular, abut the end wall of the shielding sleeve when the contact sleeve module has been inserted into the shielding sleeve. In one configuration, the end wall can form the one axial end of the shielding sleeve. In another advantageous configuration, the intermediate wall is spaced from the end wall.

On the end wall, the shielding sleeve can comprise at least one passage opening through which the contact sections of the contact sleeve modules project. Several contact sections can project through a single passage opening or one respective contact section projects through one respective passage opening.

An electrical connector, in particular a multipolar one, which comprises a housing assembly as described above, can have at least one cable extending through the central receptacle and the contact section, the shielding of which is connected in an electrically conductively manner to the contact section.

The contact section can be in direct contact with the shielding of the cable passing therethrough. For example, the contact section can be crimped onto the shielding.

In another configuration, the electrical connector comprises a cable sleeve that can be pushed into or onto the contact section of the contact sleeve module and is preferably directly connected to the shielding of the cable.

In one variant, the point at which the cable sleeve is electrically connected to the shielding of the cable can be axially spaced from the point at which the cable sleeve is connected to the contact section of the contact sleeve module through which the cable passes. In this variant, the cable sleeve represents the electrical connection between the shielding and the contact section. The outer sheath of the cable can also be mechanically affixed by the cable sleeve to enable strain relief for the electrical connection.

The shielding braid or, equivalently, the shielding of the cable can be clamped, in particular crimped, between the cable sleeve and the contact sleeve module. In this case, the cable sleeve can be located radially outside or within the shielding.

The cable sleeve, the shielding and the contact section can be connected to one another at one point by way of a single crimp connection. Alternatively or cumulatively, the cable sleeve can be crimped onto the shield also axially spaced from the contact section.

In a further variant, only the cable sleeve can be crimped to the contact section. Instead of a crimp connection between the contact section and the cable sleeve, a frictionally engaged connection can also be given. For example, the cable sleeve can be pressed onto the contact section or pressed into the contact section. Such pressing onto or pressing into can also be carried out with the shielding interposed between the cable sleeve and the contact sleeve module. Alternatively, the connection between the cable sleeve and the contact section or between a braided shield of a cable and the contact section can also be established in a material bond, for example, by soldering and/or welding and/or by other press-fit, material bond or positive-fit connections.

In one embodiment, the electrical connector can comprise the housing assembly and at least two electrical cables. One cable or conductor each can extend through a central receptacle and a contact section. The shielding of each cable can be exposed in sections and connected to one contact section each.

In order to assemble the electrical connector, the at least two cables can first be connected to the at least two contact sleeve modules outside the shielding sleeve before the at least two contact sleeve modules are inserted together into the shielding sleeve and firmly attached to the shielding sleeve and to one another by frictional engagement.

The invention finally relates to a set comprising at least two electrical connectors with identical contact sleeve modules, wherein one of the at least two connectors comprises cables that can have a different cable diameter than the cables of another of the at least two connectors.

### BRIEF DESCRIPTION OF THE DRAWINGS

In the following, the invention shall be described by way of example using an embodiment with reference to the drawings. In the drawings, the same reference characters are used for elements which correspond to one another with regard to function and/or structure,

In accordance with the above description, a feature of the embodiment can be omitted if the technical effect associated with this feature is not important for a specific application. Conversely, a feature that is not yet present there can also be added to the embodiment in accordance with the above description if the technical effect of the feature to be added is important for a specific application.

FIG. 1 shows an illustration of the housing assembly with the shielding sleeve and the contact sleeve modules;

FIG. 2 shows a front and rear view of contact sleeve modules;

FIG. 3 shows a top view onto the housing assembly with two contact sleeve modules;

FIG. 4 shows a top view onto the housing assembly with four contact sleeve modules; and

FIG. 5 shows an illustration of an electrical connector in a partially assembled state.

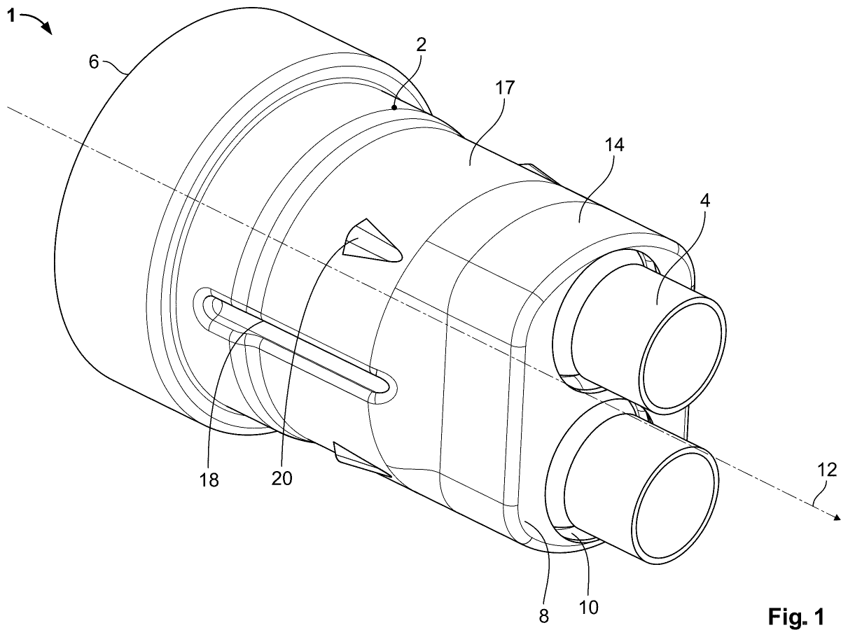

FIG. 1 shows a housing assembly 1 that is illustrated with a shielding sleeve 2 and two contact sleeve modules 4.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

Shielding sleeve 2 can be substantially hollow-cylindrical and comprise a central receptacle 6. Central receptacle 6 can be open on one side and comprise an end wall 8 with at least one, presently, for example, two passage openings 10 on the other side. Contact sleeve modules 4 can project out from passage openings 10. End wall 8 can thereby form the end of shielding sleeve 2. The number of passage openings 10 in the end wall can vary. For example, there can be only one passage opening 10 present in end wall 8, or there can just as well at least two passage openings 10 can be present.

Central receptacle 6 passes through shielding sleeve 2 along an axial direction 12. Along this direction 12, in the direction from the open side of central receptacle 6 to end wall 8, shielding sleeve 2 can be provided with a taper 14. This taper 14 can connect different assembly interfaces to one another. The diameter of taper 14 can preferably become steadily smaller along axial direction 12 towards end wall 8. In the region of its smallest diameter, taper 14 can nestle against contact sleeve modules 4.

Shielding sleeve 2 can be configured monolithically. Shielding sleeve 2 and/or contact sleeve modules 4 are made, for example, from a material containing metal, in particular from metal and/or a plastic material containing metal, and are electrically conductive. Shielding sleeve 2 and/or contact sleeve modules 4 can be made from sheet metal, in particular be deep-drawn.

The basic geometry and/or the dimensions of shielding sleeve 2 can be easily adapted to any number of cables 16. For this purpose, for example, only the shape of end wall 8 needs to be changed and/or the diameter of shielding sleeve 2 needs to be changed.

Shielding sleeve 2 on the outer side of its circumference 17 can comprise recesses 18 and/or elevations 20 which are useful for easy handling, easy assembly, in particular easy positioning, and stable fastening. Recesses 18 and/or elevations 20 can, in this case, extend axially between central receptacle 6 and taper 14. In particular, recesses 18 and/or elevations 20 can serve as guides to facilitate positioning shielding sleeve 2 in a housing (not shown). Elevations 20 and/or recesses 18 can also be part of a coding that counteracts incorrect insertion. Furthermore, recesses 18 and/or elevations 20 can be used as positive-fit or frictionally-engaged elements that can be engaged with the housing of shielding sleeve 2.

At least one contact sleeve module 4 is inserted into shielding sleeve 2, the cylindrical contact section 22 of which projects from at least one passage opening 10 of end wall 8. End wall 8 is spaced from at least one contact sleeve module 4 according to a further configuration, but can also abut contact sleeve module 4. At least one contact sleeve module 4 can advantageously be made of metal, and sheet metal can also be selected in order to utilize the same advantages of easy moldability and low weight. Alternatively, contact sleeve module 4 can also be made of a conductive plastic material, for example, one containing metal.

At least one contact sleeve module 4 is affixed in shielding sleeve 2 in a frictionally engaged manner, in particular exclusively in a frictional engaged manner, in the assembled state. In an advantageous embodiment, at least one contact sleeve module 4 is held in shielding sleeve 2 by a press fit.

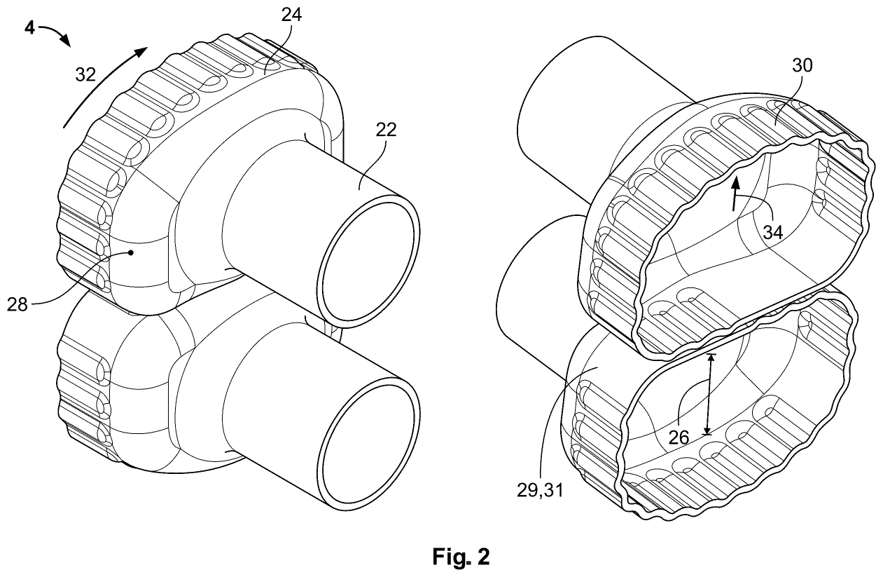

In FIG. 2, two contact sleeve modules 4 are shown by way of example and project through two passage openings 10 of shielding sleeve 2. However, the number of contact sleeve modules 4 is arbitrary. If several contact sleeve modules 4 are present, at least two contact sleeve modules 4 can be configured to be identical in order to reduce the number of different parts.

At least two contact sleeve modules 4 are preferably connected to shielding sleeve 2 in a frictionally engaged manner. Contact sleeve modules 4 can also be in frictional engagement with one another.

In FIG. 2, contact sleeve modules 4 are shown abutting one another and are inserted, in particular pressed or, presently equivalently, forced together into shielding sleeve 2 (FIG. 1) in this formation, as a package. In this embodiment, contact sleeve modules 4 in an axial plane (parallel to axial direction 12) are each approximately bell-shaped. Transverse to axial direction 12, contact sleeve modules 4 can have various geometric shapes, such as a circular shape, a shape of a circular sector, or a kidney shape. Contact sleeve modules 4, which are presently configured to be identical, can be inserted into shielding sleeve 2 rotated relative to one another about an axis extending parallel to axial direction 12.

A contact sleeve module 4 can comprise a clamping section 24 which transitions to one (or more) stub-shaped, in particular hollow-cylindrical, contact section 22. Contact section 22 can have a smaller clearance 26 than clamping section 24. An intermediate wall—or also equivalently a transition region—28 pointing in axial direction 12 is formed as a transition between clamping section 24 and contact section 22. In the assembled state of the contact sleeve module, intermediate wall 28 can abut end wall 8 of shielding sleeve 2. Advantageously, intermediate wall 28 can also be spaced from end wall 8. Intermediate wall 28 can extend, as shown in FIG. 2, in an annular shape around contact section 22. Clamping section 24 can be formed, for example, by a collar 29 that projects axially from intermediate wall 28 in one direction, while contact section 22 projects axially from intermediate wall 28 in the opposite direction. Intermediate wall 28 can be slightly inclined relative to axial direction 12.

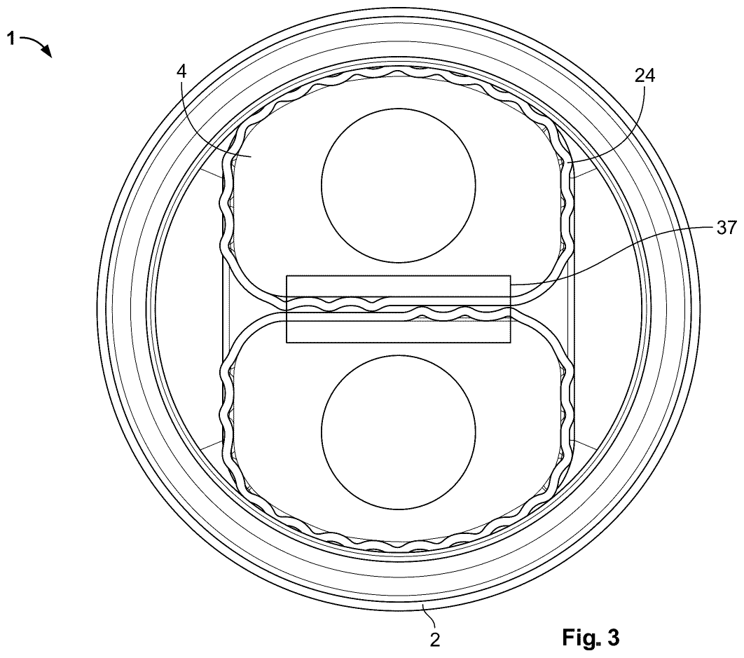

A contact sleeve module 4 can comprise projections 30 spaced from one another in the circumferential direction, at least in the regions of its outer circumference 31 in which it is in contact with shielding sleeve 2. For example, clamping section 24 comprises projections 30 that extend along axial direction 12 (FIG. 1) and form a linear contact with shielding sleeve 2 and at least one other contact sleeve module 4. In particular, projections 30 can be configured as ribs that project outwardly in radial direction 34. The outer contour of contact sleeve module 4, in particular of clamping section 24, can be configured in a wave-shaped manner as shown in FIG. 3. Furthermore, clamping section 24 can be wave-shaped only in sections. Another alternative can be nubs as projections 30, which then establish substantially punctiform contact with shielding sleeve 2 and with at least one other contact sleeve module 4.

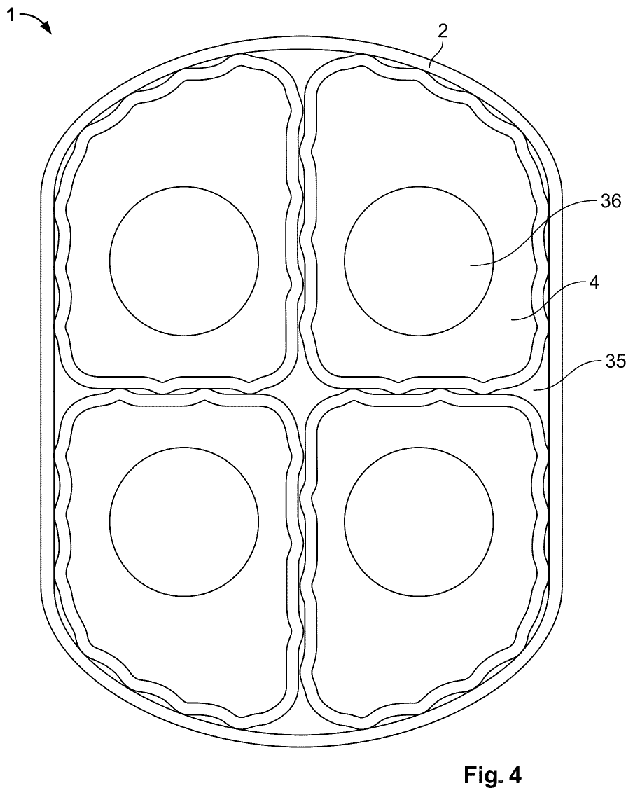

The outer contour of clamping section 24 or the outer contour formed jointly by several clamping sections 24 can be configured to be complementary to inner contour 35 (FIG. 4) of shielding sleeve 2 in order to create the largest possible contact region. The outer contour of clamping section 24 of a contact sleeve module 4 can also be complementary to the outer contour of clamping section 24 of another contact sleeve module 4, at least in region 37 (FIG. 3) in which they touch, and can be configured to be likewise complementary to outer contour 24 of other abutting contact sleeve module 4 in order to create a large contact region there as well, not only with inner contour 35 of shielding sleeve 2, but also with each other.

Region 37, where contact sleeve modules 4 touch each other, can be flattened, in particular flattened on one side. In particular, projections 30 of one contact sleeve module 4 can abut, at least in sections, a flat surface of other contact sleeve module 4. The outer contours of respective clamping sections 24 can be rotationally symmetrical. In particular, when contact sleeve modules 4 are abutting one another, a projection 30 of one contact sleeve module 4, in particular of clamping section 24, can be disposed between two projections 30 of other contact sleeve module 4 that are spaced in circumferential direction 32. Projection 30 of one contact sleeve module 4 can abut a surface that is as flat as possible, in particular not concave, between two spaced projections 30 of other contact sleeve module 4.

Spaced projections 30 of a contact sleeve module 4 together with the flat sections disposed between them or sections that are shaped to be complementarily to projections 30 of other contact sleeve module 4 can form a wave shape over the entire circumference of clamping section 24. Projections 30 form the positive, radially outward-pointing deflections of the waveform, while the sections formed to be flat or complementary to projections 30 form the wave depressions or troughs, i.e. the negative, radially inward-pointing deflections.

Together, contact sleeve modules 4 can have a shape that is complementary to the inner cross section of shielding sleeve 2, for example, a circular arc shape.

Two variants of contact sleeve module 4 are shown in FIG. 3 and FIG. 4, each in a top view onto central receptacle 6 of shielding sleeve 2: The embodiment with two contact sleeve modules 4 is shown in FIG. 3 and an embodiment with four contact sleeve modules 4 is shown in FIG. 4. The number of contact sleeve modules 4 can be variably adapted to cable 16 respectively used and can be extended, for example, to eight or nine contact sleeve modules 4.

Contact sleeve modules 4 nestle with their clamping sections 24 in sections against interior 35 of shielding sleeve 2 and against each other. In regions 37 in which contact sleeve modules 4 are in contact with each other, clamping sections 24 also complement each other. A shielded cable 16 is guided through each of openings 36 of contact sleeve modules 4.

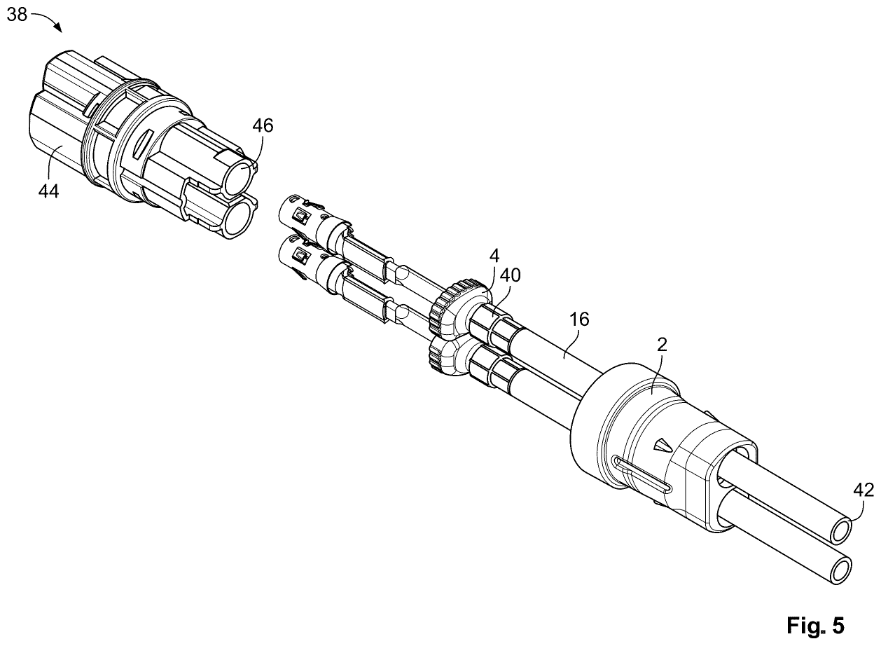

Parts of a multipolar electrical connector 38 with housing assembly 1 and two shielded cables 16 are shown by way of example in FIG. 5 in a partially assembled state.

In an advantageous configuration, electrical connector 38 can in particular comprise at least one cable sleeve 40 that can be pushed onto or into a contact section 22 of at least one contact sleeve module 4.

Shielding 42 of cable 16 can be connected to contact section 22 of contact sleeve module 4 via at least one cable sleeve 40. Shielding 42 of cable 16 can be clamped between cable sleeve 40 and contact section 22 of contact sleeve module 4.

Cable sleeve 40 can have a slightly larger diameter than contact section 22. Alternatively, cable sleeve 40 can have a smaller diameter than contact section 22 and can be pushed into contact section 22 in order to clamp shielding 42 of cable 16.

Shielding 42 of cable 16 can be connected by way of at least one crimp connection.

In a further configuration, cable 16 with a small cable diameter can also be crimped directly onto contact section 22 of contact sleeve module 4.

Electrical connector 38 can comprise a contact part carrier 44 to which cables 16 are connected, for example, by way of socket contacts. Contact part carrier 44 with the socket contacts can then be used as a connecting link to an external interface. Contact part carrier 44 comprises the same number of receptacles 46 as there are cables 16.

In order to press contact sleeve modules 4 into shielding sleeve 2, contact part carrier 44 can be used as an assembly aid. An assembly aid that resembles the shape of contact part carrier 44 is also conceivable for pressing contact sleeve modules 4 into shielding sleeve 2.

In this embodiment, shieldings 42 of cables 16 are each slipped over a contact section 22 of contact sleeve modules 4. Cables 16 are each connected to contact section 22 of the contact sleeve module 4 using a cable sleeve 40 each that is pushed onto shielding 42 and contact section 22. The frictionally engaged connection of contact sleeve module 4 to shielding sleeve 2 establishes current transmission.

In an advantageous configuration, cables 16 can be connected to contact sleeve modules 4 only via the respective contact section 22; one cable sleeve 40 each can be used for this purpose. Contact sleeve modules 4 connected to cables 16 can thereafter be placed next to one another and inserted together into shielding sleeve 2 and affixed in place by frictional engagement.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A housing assembly for an electrical connector, wherein the housing assembly comprises a shielding sleeve made of electrically conductive material;
wherein the shielding sleeve comprises a central receptacle that axially penetrates the shielding sleeve for receiving at least one shielded cable;
wherein at least one contact sleeve module made of electrically conductive material is inserted into the central receptacle; and wherein
the contact sleeve module comprises at least one passage opening for the at least one shielded cable;
is provided with at least one contact section for contacting a shielding of the at least one shielded cable; and
is affixed in the assembled state in the shielding sleeve in a frictionally engaged manner.

2. The housing assembly according to claim 1, wherein at least two contact sleeve modules are connected to one another and to the shielding sleeve in a frictionally engaged manner.

3. The housing assembly according to claim 2, wherein the at least two contact sleeve modules are held in the shielding sleeve by way of a press fit.

4. The housing assembly according to claim 1, wherein the at least one contact sleeve module is provided, at least in the regions in which it is frictionally engaged with the shielding sleeve, with projections spaced from one another on its outer circumference.

5. The housing assembly according to claim 4, wherein the projections are spaced from one another in circumferential direction.

6. The housing assembly according to claim 4, wherein the projections are axially elongated.

7. The housing assembly according to claim 1, wherein the contact section is cylindrical.

8. The housing assembly according to claim 1, wherein the contact section projects out from the shielding sleeve.

9. The housing assembly according to claim 1, wherein the contact sleeve module comprises a clamping section, on the outer circumference of which the region is located which is in frictional engagement with the shielding sleeve.

10. The housing assembly according to claim 9, wherein the contact section comprises a smaller clearance than the clamping section.

11. The housing assembly according to claim 9, wherein the clamping section in the transition to the contact section comprises an intermediate wall pointing in the axial direction.

12. An electrical connector with a housing assembly according claim 1 and with at least one shielded cable, extending through the central receptacle and the contact section of a contact sleeve module, the shielding of which is connected to the contact sleeve module.

13. The electrical connector according to claim 12 with at least one separate cable sleeve which is connected to the shielding of the cable and which is pushed onto or into the contact section.

14. The electrical connector according to claim 12, wherein the cable sleeve is crimped onto the cable.

15. A set comprising at least two electrical connectors according to one of the claim 12, wherein the at least two electrical connectors comprise identical contact sleeve modules, wherein one of the at least two connectors comprises cables that can have a different cable diameter than the cables of another of the at least two connectors.
